(19) United States
(12) Patent Application Publication
(10) Pub. No.: US 2006/0255502 A1
(43) Pub. Date: Nov. 16, 2006

(54) Method for the production of golf ball

(75) Inventors: Masatoshi Yokota, Kobe-shi (JP); Kazuya Kamino, Kobe-shi (JP)

Correspondence Address: BIRCH STEWART KOLASCH & BIRCH, PO BOX 747, FALLS CHURCH, VA, 22040-0747, US

(73) Assignee: SRI Sports Limited

(21) Appl. No.: 11/409,962

(22) Filed: Apr. 25, 2006

(30) Foreign Application Priority Data
May 12, 2005 (JP) 2005-139373

(51) Int. Cl. B29C 65/00

(52) U.S. Cl. 264/248; 264/320

(57) ABSTRACT

A half shell having a top part thickness of 65% or greater and 95% or less and a side part thickness of 100% or greater and 120% or less of the nominal thickness T of the cover is formed. Next, the core 4 composed of the center and the mid layer is fitted to two pieces of the half shell 46. Next, the core 4 and the half shell 46 are placed into a mold 32. Next, the mold 32 is clamped at a speed of 0.5 mm/sec or greater and 2.0 mm/sec or less. The thermoplastic resin composition of the half shell 46 is heated while being compressed in the spherical cavity to result in flow. This resin composition is hardened to give a cover having a thickness of 0.1 mm or greater and 0.8 mm or less. Dimples are formed on the cover by way of pimples 40. Recessed parts are formed on the mid layer by way of the pimples 40.

This application claims priority on Patent Application No. 2005-139373 filed in JAPAN on May 12, 2005, the entire contents of which are hereby incorporated by reference.

### BACKGROUND OF THE INVENTION

1. Field of the Invention

The present invention relates to methods for the production of golf balls. More particularly, the present invention relates to compression molding of a golf ball.

2. Description of the Related Art

General golf balls have a core and a cover. The cover usually comprises a thermoplastic resin composition. The cover is formed by injection molding or compression molding. Dimples are formed on the surface of the cover.

The injection molding is excellent in mass production capability. In the injection molding, the core is first retained at the center of a spherical cavity by a retaining pin. Next, a molten thermoplastic resin composition is injected into a gap between the cavity face and the core. Because the retaining pin shifts backward in a final stage of the injection, the core may migrate from the center, concurrent with the flow of the resin composition. The migration results in unevenness in the thickness of the cover (generally referred to as “uneven thickness”). The air which is present in the gap between the cavity face and the core is discharged from a bent hole or a clearance of the retaining pin in accordance with the influx of the resin composition. When this discharge is insufficient, defective appearance due to the residual air occurs. Accordingly, difficulties are involved in the production of a high quality golf ball by the injection molding.

In the compression molding, two pieces of half shell composed of a thermoplastic resin composition, and a core covered by these half shells are placed into a mold. This mold comprises upper and lower mold halves. By clamping this mold, the resin composition is compressed, and the excess resin composition outflows from the parting line. The air which is present between the core and the half shell is discharged from the parting line concomitant with the outflow of the resin composition. Process for such compression molding is disclosed in US2004/0232590A1 (JP-A No.2004-344386).

In the compression molding, the half shell causes thermal contraction during the mold clamping in progress. This thermal contraction increases the volume of the resin composition in the vicinity of the top part. According to thus resulting golf ball, cover thickness at the pole corresponding to the top part of the half shell is greater than the cover thickness at the seam corresponding to the side part of the half shell. In other words, uneven thickness of the cover is generated by the thermal contraction. Particularly, thermal contraction is apt to occur when the mold clamping speed is slow. Lopsided outflow of the resin composition toward a certain direction also generates uneven thickness in the compression molding. In particular, when the amount of outflow is abundant, uneven outflow is apt to take place. The uneven thickness adversely affects durability and other performances of the golf ball. Particularly, in golf balls having a cover with small nominal thickness, great adverse effects are exerted on durability due to the uneven thickness.

The cover is thin immediately below the dimples. Upon repeated impacts of the golf ball, such a place immediately below the dimple becomes the starting point of the crack, which may lead to breakage of the cover. Covers having a small nominal thickness are particularly apt to be broken.

In recent years, in light of achieving well balanced control performance and flight performance, golf balls having a thin cover were proposed, and have been available in the market. In this type of golf balls, there has been an urgent need to improve the durability. An object of the present invention is to provide a golf ball having a cover with a small nominal thickness, exhibiting uneven thickness not that much, and being excellent in durability.

### SUMMARY OF THE INVENTION

The method of the production according to the present invention comprises:
(1) a core forming step in which a center is covered by a mid layer comprising a thermoplastic resin composition to obtain a core,
(2) a half shell forming step in which a half shell is formed which comprises other thermoplastic resin composition and is bowl-shaped,
(3) a placing step in which the core, and two pieces of the half shell fitted to the core are placed in a mold comprising an upper mold half and a lower mold half having a hemispherical cavity face and having numerous pimples on the surface thereof, in the state of this mold being released,
(4) a mold clamping step in which the mold is clamped to allow the thermoplastic resin composition of the half shell to be compressed in the spherical cavity while being heated, thereby discharging excessive thermoplastic resin composition from the spherical cavity, and pushing the mid layer by the pimples to form recesses, and
(5) a hardening step in which the thermoplastic resin composition remaining in the spherical cavity is hardened to form a cover having a nominal thickness T of 0.1 mm or greater and 0.8 mm or less. The half shell obtained in the half shell forming step has a top part thickness Tt of 65% or greater and 95% or less and a side part thickness Ts of 100% or greater and 120% or less of the nominal thickness T of the cover. The nominal thickness according to the present invention means a value obtained by subtracting the radius of the core from the radius of the golf ball before painting.

Preferably, mold clamping speed in the mold clamping step is 0.5 mm/s or greater and 2.0 mm/s or less.

Preferably, this method of the production further comprises following the mold clamping step a high pressure step in which the resin composition of the half shell is compressed in the spherical cavity under a pressure that is higher than the pressure in the mold clamping step. Preferably, the compressive force in the high pressure step is 17652 N or greater and 40207 N or less. Preferably, time period of the high pressure step is 30 sec or longer and 300 sec or shorter.

According to this method of the production, a golf ball having a small difference between the cover thickness at the pole and the cover thickness at the seam can be obtained. According to this method of the production, uneven thickness can be suppressed. According to this method of the production, a golf ball having a cover with numerous dimples and having a mid layer with numerous recessed parts at positions corresponding to the pimples can be obtained. In the golf ball obtained by this method of the production, the cover thickness immediately below the dimple becomes great. This golf ball is excellent in durability.

### BRIEF DESCRIPTION OF THE DRAWINGS

FIG. 1 is a partially cut off cross-sectional view illustrating a golf ball obtained by the method of the production according to one embodiment of the present invention;

FIG. 2 is a cross-sectional view illustrating a part of the first mold for use in the production of the golf ball shown in FIG. 1;

FIG. 3 is a cross-sectional view illustrating a part of the second mold for use in the production of the golf ball shown in FIG. 1;

FIG. 4 is an enlarged cross-sectional view illustrating a half shell shown in FIG. 3;

FIG. 5 is an enlarged cross-sectional view illustrating a part of the golf ball shown in FIG. 1; and

FIG. 6 is a cross-sectional view illustrating a half shell for use in the method of the production according to another embodiment of the present invention.

### DESCRIPTION OF THE PREFERRED EMBODIMENTS

The present invention is hereinafter described in detail with appropriate references to the accompanying drawing according to the preferred embodiments.

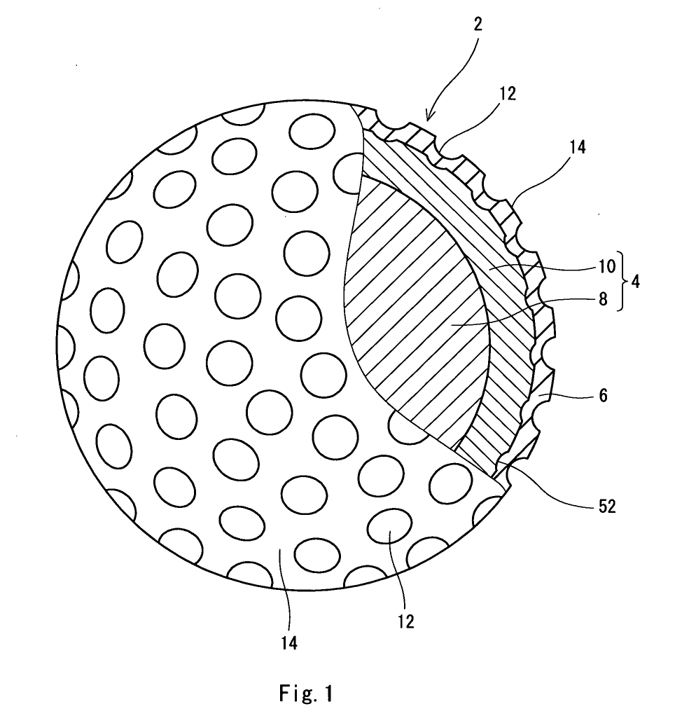

A golf ball 2 depicted in FIG. 1 has a spherical core 4, and a cover 6 covering this core 4. The core 4 includes a spherical center 8, and a mid layer 10 covering this center 8. Numerous dimples 12 are formed on the surface of the cover 6. Of the surface of the cover 6, a part except for the dimples 12 is a land 14. Although this golf ball 2 has a paint layer and a mark layer to the external side of the cover 6, these layers are not shown in the Figure.

This golf ball 2 has a diameter of from 40 mm to 45 mm. From the standpoint of conformity to a rule defined by United States Golf Association (USGA), the diameter is preferably equal to or greater than 42.67 mm. In light of suppression of the air resistance, the diameter is preferably equal to or less than 44 mm, and more preferably equal to or less than 42.80 mm. Weight of this golf ball 2 is 40 g or greater and 50 g or less. In light of attainment of great inertia, the weight is preferably equal to or greater than 44 g, and more preferably equal to or greater than 45.00 g. From the standpoint of conformity to a rule defined by USGA, the weight is preferably equal to or less than 45.93 g.

The center 8 is obtained through crosslinking of a rubber composition. Illustrative examples of the base rubber for use in the rubber composition include polybutadienes, polyisoprenes, styrene-butadiene copolymers, ethylene-propylene-diene copolymers and natural rubbers. Two or more kinds of the rubbers may be used in combination. In light of the resilience performance, polybutadienes are preferred, and particularly, high cis-polybutadienes are preferred.

For crosslinking of the center 8, a co-crosslinking agent is usually used. Preferable co-crosslinking agent in light of the resilience performance may be zinc acrylate, magnesium acrylate, zinc methacrylate and magnesium methacrylate. Into the rubber composition, an organic peroxide may be preferably blended together with the co-crosslinking agent. Examples of suitable organic peroxide include dicumyl peroxide, 1,1-bis(t-butylperoxy)-3,3,5-trimethylcyclohexane, 2,5-dimethyl-2,5-di(t-butylperoxy)hexane and di-t-butyl peroxide.

Various kinds of additives such as a filler, a sulfur compound, an anti-aging agent, a coloring agent, a plasticizer, a dispersant and the like may be blended at an adequate amount to the rubber composition as needed. Into the rubber composition may be also blended crosslinked rubber powder or synthetic resin powder.

The center 8 has a diameter of equal to or greater than 30.0 mm, and particularly equal to or greater than 35.0 mm. The center 8 has a diameter of equal to or less than 41.5 mm, and particularly equal to or less than 41.0 mm. The center 8 may be subjected to a surface treatment such as grinding, brushing, flaming, a plasma treatment or the like. The center 8 may be composed of two or more layers. Other layer comprising a thermoplastic resin composition may be also provided between the center 8 and the mid layer 10.

The mid layer 10 comprises a thermoplastic resin composition. Illustrative examples of the base polymer for use in this resin composition include ionomer resins, thermoplastic polyester elastomers, thermoplastic polyamide elastomers, thermoplastic polyurethane elastomers, thermoplastic polyolefin elastomers and thermoplastic polystyrene elastomers. In particular, an ionomer resin is preferred. Ionomer resins are highly elastic. As described later, this golf ball 2 has a very thin cover 6. Upon impacts of this golf ball 2 with a driver, the mid layer 10 is greatly deformed. The mid layer 10 in which an ionomer resin is used is responsible for the flight performance upon shots with a driver. When other resin is used in combination with an ionomer resin, the ionomer resin is included as a principal component of the base polymer, in light of the flight performance. Proportion of the ionomer resin occupying in the total base polymer is preferably equal to or greater than 50% by weight, more preferably equal to or greater than 70% by weight, and particularly preferably equal to or greater than 85% by weight.

Preferably, an ionomer resin may be used that is a copolymer of α-olefin and an α, β-unsaturated carboxylic acid having 3 to 8 carbon atoms in which a part of the carboxylic acid is neutralized with a metal ion. Examples of preferable α-olefin include ethylene and propylene. Examples of preferable α, β-unsaturated carboxylic acid include acrylic acid and methacrylic acid. Illustrative examples of the metal ion for use in the neutralization include sodium ion, potassium ion, lithium ion, zinc ion, calcium ion, magnesium ion, aluminum ion and neodymium ion. The neutralization may also be carried out with two or more kinds of the metal ions. In light of the resilience performance and durability of the golf ball 2, examples of particularly suitable metal ion include sodium ion, zinc ion, lithium ion and magnesium ion.

Specific examples of the ionomer resin include trade names “Himilan 1555”, “Himilan 1557”, “Himilan 1605”, “Himilan 1706”, “Himilan 1707”, “Himilan AM 7311”, “Himilan AM 7315”, “Himilan AM 7317”, “Himilan AM 7318”, “Himilan AM 7329” and “Himilan MK 7320”, available from Du Pont-MITSUI POLYCHEMICALS Co., Ltd.; trade names “Surlyn® 7930”, “Surlyn® 7940”, “Surlyn® 8140”, “Surlyn® 8940”, “Surlyn® 8945”, “Surlyn® 9120”, “Surlyn® 9910” and “Surlyn® 9945”, available from Dupont; and trade names “IOTEK 7010”, “IOTEK 7030”, “IOTEK 8000” and “IOTEK 8030”, available from EXXON Corporation.

In light of the flight performance, the mid layer 10 has a thickness of preferably equal to or greater than 0.3 mm, more preferably equal to or greater than 0.5 mm, and particularly preferably equal to or greater than 0.7 mm. In light of the feel at impact, the thickness is preferably equal to or less than 2.5 mm, and more preferably equal to or less than 2.0 mm.

In light of adhesion between the mid layer 10 and the cover 6, the mid layer 10 is preferably subjected to a surface treatment to increase the roughness thereof. Specific examples of the surface treatment include brushing, grinding and the like.

The cover 6 comprises a thermoplastic resin composition. Illustrative examples of the base polymer of this resin composition include thermoplastic polyurethane elastomers, thermoplastic polyester elastomers, thermoplastic polyamide elastomers, thermoplastic polyolefin elastomers, thermoplastic polystyrene elastomers and ionomer resins. It is preferred that a thermoplastic polyurethane elastomer is used as the base polymer. The thermoplastic polyurethane elastomers are soft. Great spin rate is achieved when the golf ball 2 having a cover 6 comprising a thermoplastic polyurethane elastomer is hit with a short iron. The cover 6 comprising a thermoplastic polyurethane elastomer is responsible for the control performance upon a shot with a short iron. The thermoplastic polyurethane elastomer is also responsible for the scuff resistance of the cover 6.

The thermoplastic polyurethane elastomer includes a polyurethane component as a hard segment, and a polyester component or a polyether component as a soft segment. Illustrative examples of the curing agent for the polyurethane component include alicyclic diisocyanates, aromatic diisocyanates and aliphatic diisocyanates. In particular, alicyclic diisocyanate is preferred. Because the alicyclic diisocyanate has no double bond in the main chain, yellowing of the cover 6 can be suppressed. Additionally, because the alicyclic diisocyanate is excellent in strength, the cover 6 can be prevented from being scuffed. Two or more kinds of diisocyanates may be used in combination.

Illustrative examples of the alicyclic diisocyanate include 4,4′-dicyclohexylmethane diisocyanate (H₁₂MDI), 1,3-bis(isocyanatomethyl)cyclohexane (H₆XDI), isophorone diisocyanate (IPDI) and trans-1,4-cyclohexane diisocyanate (CHDI). In light of versatility and processability, H₁₂MDI is preferred.

Illustrative examples of the aromatic diisocyanate include 4,4′-diphenylmethane diisocyanate (MDI) and toluene diisocyanate (TDI). Illustrative examples of the aliphatic diisocyanate include hexamethylene diisocyanate (HDI).

Specific examples of the thermoplastic polyurethane elastomer include trade name “Elastollan XNY90A”, trade name “Elastollan XNY97A”, trade name “Elastollan XNY585” and trade name “Elastollan XKP016N”, available from BASF Japan Ltd; and trade name “Rezamin P4585LS” and trade name “Rezamin PS62490”, available from Dainichiseika Color & Chemicals Mfg. Co., Ltd.

When other resin is used in combination with the thermoplastic polyurethane elastomer in the cover 6, the thermoplastic polyurethane elastomer is included in the base polymer as a principal component, in light of the control performance. Proportion of the thermoplastic polyurethane elastomer occupying in the total base polymer is preferably equal to or greater than 50% by weight, more preferably equal to or greater than 70% by weight, and particularly preferably equal to or greater than 85% by weight.

Into the cover 6 may be blended a coloring agent such as titanium dioxide, a filler such as barium sulfate, a dispersant, an antioxidant, an ultraviolet absorbent, a light stabilizer, a fluorescent agent, a fluorescent brightening agent and the like in an appropriate amount as needed. Also, the cover 6 may be blended with powder of a highly dense metal such as tungsten, molybdenum or the like for the purpose of adjusting the specific gravity.

The cover 6 has a nominal thickness T of equal to or less than 0.8 mm. As described above, the cover 6 has a low hardness. The cover 6 having such a low hardness is disadvantageous in terms of the resilience coefficient of the golf ball 2. Upon shots with a driver, the mid layer 10 as well as the center 8 of the golf ball 2 is deformed greatly. By setting the nominal thickness T of the cover 6 to be equal to or less than 0.8 mm, the cover 6 does not adversely affect the resilience coefficient to a large extent upon a shot with a driver, even though the cover 6 has a low hardness. In light of the flight performance and ease in molding, the cover 6 has a nominal thickness T of more preferably equal to or less than 0.6 mm, and particularly preferably equal to or less than 0.5 mm. In light of ease in forming the cover 6, the nominal thickness T is preferably equal to or greater than 0.1 mm, and more preferably equal to or greater than 0.2 mm.

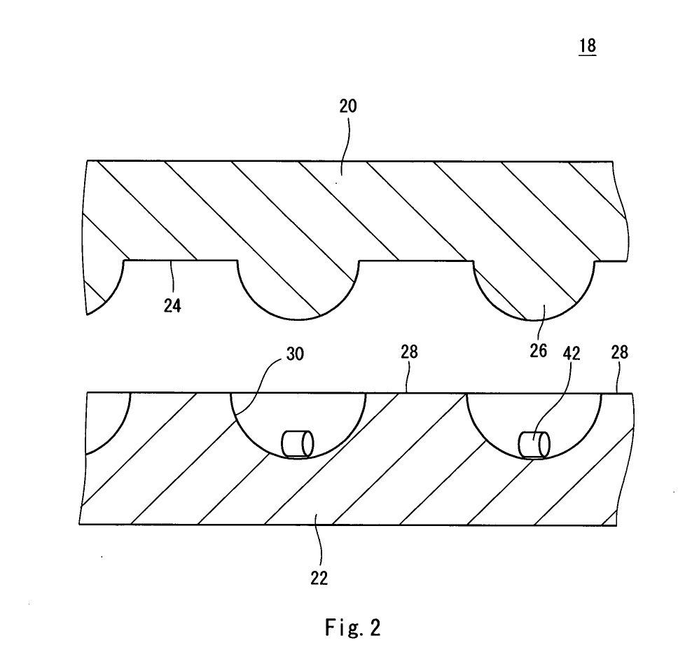

FIG. 2 is a cross sectional view illustrating a part of a first mold 18 for use in the production of the golf ball 2 shown in FIG. 1. The first mold 18 has an upper mold half 20 and a lower mold half 22. The upper mold half 20 has a flat part 24 and a protruding part 26. The surface of the protruding part 26 has a shape that is substantially hemispherical. The lower mold half 22 has a flat part 28 and a recessed part 30. The surface of the recessed part 30 has a shape that is substantially hemispherical. The protruding part 26 has a radius that is smaller than the radius of the recessed part 30. When the upper mold half 20 and the lower mold half 22 are mated, a space is formed between the protruding part 26 and the recessed part 30. When the upper mold half 20 and the lower mold half 22 are mated, a space is formed also between the flat part 24 of the upper mold half 20 and the flat part 28 of the lower mold half 22. Preferably, the first mold 18 may be subjected to a treatment for forming a plated layer having a surface roughened with a chemical treatment, and a fluorine-contained resin-coated layer that is laminated on this plated layer. In this treatment, the main body of the first mold 18 is first subjected to electroless plating. Typically, electroless nickel plating is carried out. Next, the surface of this plated layer is roughened by a chemical treatment. Subsequently, to this plated layer is applied a fluorine-contained resin, followed by baking. Baking allows for entry of the fluorine-contained resin into fine depressed portions of the plated layer.

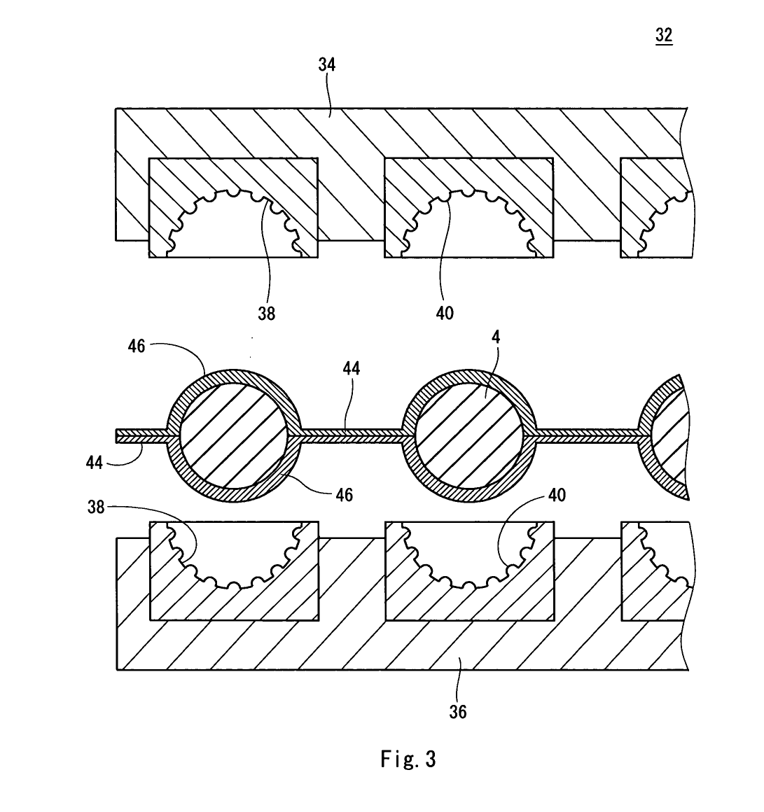

FIG. 3 is a cross sectional view illustrating a part of a second mold 32 for use in the production of the golf ball 2 shown in FIG. 1. The second mold 32 has an upper mold half 34 and a lower mold half 36. Each of the upper mold half 34 and the lower mold half 36 has numerous cavity faces 38, respectively, and hemispherical cavities are formed by these cavity faces 38. When the upper mold half 34 and the lower mold half 36 are mated, spherical cavities are formed. Numerous pimples 40 are formed on the cavity face 38.

Upon production of the golf ball 2, a base rubber, a crosslinking agent and various additives are first kneaded to obtain a rubber composition. Next, this rubber composition is placed into a mold having an upper mold half and a lower mold half, and having a spherical cavity (not shown in the Figure). Next, this mold is clamped. Next, the rubber composition is heated via the mold. Heating causes a crosslinking reaction of the rubber. The rubber composition is cured through crosslinking. The mold is released, and a spherical center 8 is removed.

This center 8 is placed into a mold having an upper mold half and a lower mold half, and having a spherical cavity (not shown in the Figure). A melted resin composition is injected around this center 8 according to injection molding. This resin composition is hardened to form the mid layer 10. Thus, the core 4 comprising the center 8 and the mid layer 10 is obtained. The mid layer 10 may be formed also by compression molding.

Next, a thermoplastic resin and additives are blended, and extruded from an extruder to give a resin composition. Next, this resin composition is cut into a predetermined size. By thus cutting, pellets 42 are obtained (see, FIG. 2). Next, the pellet 42 is placed into the first mold 18. As shown in FIG. 2, the pellet 42 is put on the recessed part 30 of the lower mold half 22. Next, the lower mold half 22 is relatively elevated toward the upper mold half 20, and mold clamping is carried out. The mold clamping is usually carried out with a pressing machine. According to the mold clamping, the pellet 42 is compressed, and heated. The compression and heating results in flow of the resin composition, thereby filling the space between the upper mold half 20 and the lower mold half 22 with the resin composition. Next, the first mold 18 is cooled. By cooling, temperature of the resin composition is also lowered. When the temperature is lowered enough, the first mold 18 is released to remove a preforming material. Because the first mold 18 had been subjected to a treatment for forming a plated layer having a surface roughened with a chemical treatment and a fluorine-contained resin-coated layer laminated on this plated layer as described above, the preforming material can be readily released from the mold. As shown in FIG. 3, the preforming material 44 has numerous half shells 46. The half shell 46 is bowl-shaped. The half shell 46 may be formed also by injection molding.

Next, as shown in FIG. 3, the core 4 is sandwiched between two pieces of the preforming material 44. The core 4 is fitted to two pieces of the half shell 46. Next, the preforming material 44 and the core 4 are placed into the second mold 32 that is released. The half shell 46 and the core 4 are usually put on the cavity face 38 of the lower mold half 36.

Next, the lower mold half 36 is relatively elevated toward the upper mold half 34, thereby allowing the lower mold half 36 to approach the upper mold half 34. This operation is usually carried out with a pressing machine. Speed of the approaching is 3.0 mm/sec or greater and 200.0 mm/sec or less. This speed is high. High speed results in achievement of a short cycle time. This step is referred to as approaching step.

The approaching step is terminated at the stage in which the distance between the upper mold half 34 and the lower mold half 36 reaches to a predetermined value. Thereafter, the lower mold half 36 is allowed to approach the upper mold half 34 at a speed of 0.5 mm/sec or greater and 2.0 mm/sec or less. The thermoplastic resin composition of the half shell 46 is heated while being compressed in the spherical cavity. The resin composition flows upon compression and heating to cover around the core 4. Excess resin composition outflows from the spherical cavity. This step is referred to as mold clamping step. In the mold clamping step, the pimples 40 push the half shell 46 and the mid layer 10. According to this pushing, the half shell 46 and the mid layer 10 are depressed. Depression of the half shell 46 results in formation of the dimples 12.

Next, pressure of the pressing machine is elevated. The resin composition of the half shell 46 is compressed in the spherical cavity at a pressure higher than the pressure in the mold clamping step. This step is referred to as high pressure step. According to the high pressure step, the upper half shell 46 and the lower half shell 46 are firmly bound. According to the high pressure step, dimples 12 are formed having a shape precisely reflecting the shape of the pimples 40.

Next, the second mold 32 is cooled in the state of the second mold 32 being clamped. By cooling, the resin composition of the half shell 46 is hardened. This resin composition constitutes the cover 6. This step is referred to as hardening step. Following the hardening, the second mold 32 is released, and the golf ball 2 is removed.

As described above, the lower mold half 36 approaches the upper mold half 34 at a speed of 0.5 mm/sec or greater and 2.0 mm/sec or less in the mold clamping step. This speed is extremely low. Because the second mold 32 migrates slowly, the air existing between the half shell 46 and the core 4, and the air existing between the half shell 46 and the cavity face 38 are discharged certainly toward outside of the spherical cavity. According to this method of the production, remnant of the air in the golf ball 2 is suppressed. Because the second mold 32 migrates slowly, uneven outflow of the resin composition hardly occurs. According to this method of the production, uneven thickness resulting from uneven outflow is hardly generated. The golf ball 2 with suppressed residual air and uneven thickness is excellent in the durability. In light of the durability, the speed of approaching the lower mold half 36 toward the upper mold half 34 in the mold clamping step is more preferably equal to or less than 1.5 mm/sec, and particularly preferably equal to or less than 1.0 mm/sec.

The compressive force in the high pressure step is preferably equal to or greater than 17652 N. By setting the compressive force to be equal to or greater than 17652 N, excessive outflow of the resin composition of the half shell 46 is suppressed, and uneven thickness is also suppressed. By setting the compressive force to be equal to or greater than 17652 N, outflow of the resin composition of the mid layer 10 is also suppressed. In this respect, the compressive force is more preferably equal to or greater than 20594 N, and particularly preferably equal to or greater than 26478 N. Because expensive equipment is required when the compressive force is enormously great, the compressive force is preferably equal to or less than 40207 N. The compressive force is a value obtained through dividing the maximum force applied to the second mold 32 with the pressing machine in the high pressure step by the number of the spherical cavities possessed by the second mold 32. The force applied to the second mold 32 with the pressing machine is a value obtained by multiplying the pressure of the ram of the pressing machine by the cross sectional area of this ram.

Time period of the high pressure step is preferably 30 sec or longer and 300 sec or shorter. By setting the time period to be equal to or longer than 30 sec, upper and lower half shells 46 are firmly mated. In this respect, the time period is more preferably equal to or longer than 70 sec, and particularly preferably equal to or longer than 100 sec. By setting the time period to be equal to or shorter than 300 sec, outflow of the resin composition of the mid layer 10 can be suppressed. In this respect, the time period is more preferably equal to or shorter than 260 sec, and particularly preferably equal to or shorter than 230 sec. In light of suppression of the uneven thickness, it is preferred that the pressure of the pressing machine is elevated immediately after completing the mold clamping step.

The difference (Tf−Fc) between the molding temperature Tf and the incipient fluidization temperature Fc of the thermoplastic resin composition of the half shell 46 (i.e., cover 6) is preferably equal to or greater than 20° C. By setting this difference (Tf−Fc) to be equal to or greater than 20° C., the cover 6 is more tightly adhered to the core 4. In this respect, the difference (Tf−Fc) is more preferably equal to or greater than 25° C. The molding temperature Tf means the maximum temperature attained by the second mold 32 during the period of from the placing step until the hardening step. The molding temperature Tf may be measured at the pole of the cavity face 38. The incipient fluidization temperature Fc may be measured by “FLOWTESTER CFT-500”, available from Shimadzu Corporation. Measurement conditions are as shown below:
Plunger area: 1 cm²
DIE LENGTH: 1 mm
DIE DIA: 1 mm
Load: 588.399 N
Starting temperature: 30° C.
Temperature elevation rate: 3° C./min.
   Prior to the measurement, the sample is retained in the circumstance at 70° C for 8 hours, and dried.

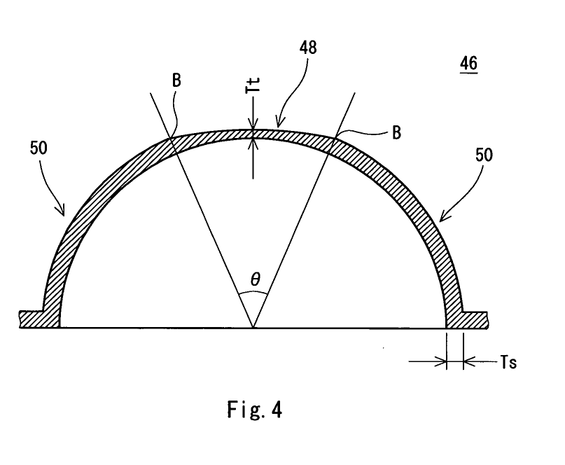

FIG. 4 shows an enlarged cross-sectional view illustrating the half shell 46 shown in FIG. 3. This half shell 46 has a top part 48 and a side part 50. In FIG. 4, what is indicated by a reference sign B is a boundary between the top part 48 and the side part 50. As is clear from FIG. 4, the top part 48 is the thinnest at its center, and the thickness is gradually increased from this center toward the boundary B. In FIG. 4, what is indicated by a both-oriented arrowhead Tt is the thickness of the top part 48. The thinnest site in the top part 48 is determined, and the thickness Tt is measured at this site. The top part 48 may have a uniform thickness. The side part 50 has a uniform thickness. In FIG. 4, what is indicated by a both-oriented arrowhead Ts is the thickness of the side part 50. Such a half shell 46 can be obtained by adjusting the shape and size of the first mold 18.

Proportion of the thickness Tt of the top part 48 to the nominal thickness T of the cover 6 is equal to or less than 95%. In other words, the top part 48 is thin. In the method of the production according to the present invention, the speed in the mold clamping step is so slow that thermal contraction of the half shell 46 is caused in the mold clamping step. This thermal contraction increases the volume of the resin composition in the vicinity of the top part 48. Because the top part 48 before heating is thin, the cover 6 is prevented from having enormously great pole thickness even though the thermal contraction is caused. In this respect, the proportion is more preferably equal to or less than 90%, and particularly preferably equal to or less than 85%. When this proportion is excessively small, bare is liable to be caused, therefore, the proportion is preferably equal to or greater than 65%, more preferably equal to or greater than 70%, and particularly preferably equal to or greater than 75%.

In light of achieving tight mating between the upper and lower half shells 46, the proportion of the thickness Ts of the side part 50 to the nominal thickness T of the cover 6 is preferably equal to or greater than 100%, and more preferably equal to or greater than 105%. In light of possible prevention of the uneven thickness due to excessive outflow of the resin composition, this proportion is preferably equal to or less than 120%, and particularly preferably equal to or less than 115%.

In light of the prevention of the uneven thickness, the top part 48 has a center angle θ of equal to or greater than 10°, and more preferably equal to or greater than 15°. In light of tight mating of the half shells 46, the center angle θ is preferably equal to or less than 60°, and more preferably equal to or less than 45°.

Proportion of the volume of the cover 6 to total volume of the upper and lower half shells 46 is preferably 110% or greater and 130% or less. By setting this proportion to be equal to or greater than 110%, the remaining of the air hardly occurs. In this respect, the proportion is more preferably equal to or greater than 120%. By setting this proportion to be equal to or less than 130%, the uneven thickness due to excessive outflow of the resin composition is prevented. In this respect, the proportion is more preferably equal to or less than 125%.

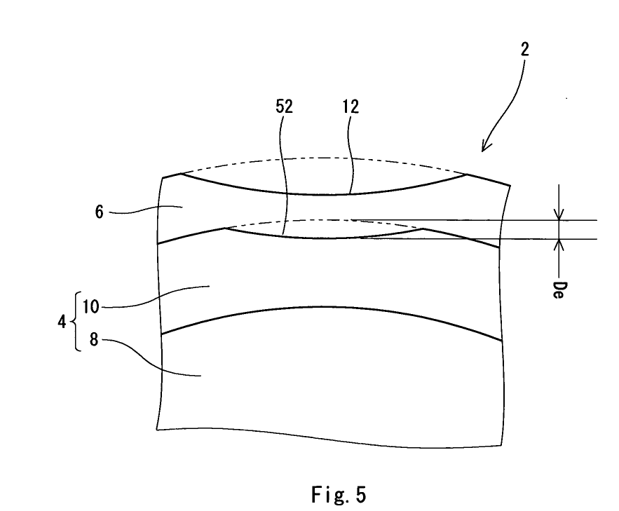

FIG. 5 is an enlarged cross-sectional view illustrating a part of the golf ball 2 shown in FIG. 1. In this Figure, the cover 6, the mid layer 10 and the center 8 are shown. The cover 6 has the dimple 12. The mid layer 10 has a recessed part 52. The dimple 12 and the recessed part 52 are formed by the pimple 40 in the mold clamping step and the high pressure step. Presence of the recessed part 52 secures the thickness of the cover 6 immediately below the dimple 12. In this golf ball 2, the dimples 12 are prevented from becoming the starting point of the crack upon repeated impacts. This golf ball 2 is excellent in durability. In light of the durability, the recessed part 52 has a depth De of preferably equal to or greater than 0.05 mm, and particularly preferably equal to or greater than 0.10 mm. The depth De of the recessed part 52 is preferably equal to or less than 0.5 mm.

For forming the recessed part 52, the mid layer 10 must be softened in the mold clamping step or the high pressure step. In this respect, the difference (Tf−Fm) between the molding temperature Tf and the incipient fluidization temperature Fm of the thermoplastic resin composition of the mid layer 10 is preferably equal to or greater than 10° C., and more preferably equal to or greater than 20° C. In light of suppression of outflow of the mid layer 10, the difference (Tf−Fm) is preferably equal to or less than 60° C.

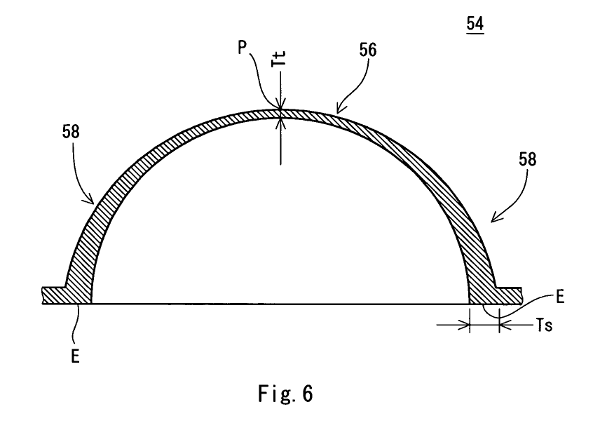

FIG. 6 is a cross-sectional view illustrating a half shell 54 for use in the method of the production according to another embodiment of the present invention. In this half shell 54, the thickness is gradually increased from the vertex P toward the end point E. The thickness Tt of the top part 56 is measured at the vertex P. The thickness Ts of the side part 58 is measured at the end point E. Golf balls with suppressed uneven thickness can be obtained also by using this half shell 54.

Also in this half shell 54, proportion of the thickness Tt of the top part 56 to the nominal thickness T of the cover is preferably equal to or less than 95%, more preferably equal to or less than 90%, and particularly preferably equal to or less than 85%. The proportion is preferably equal to or greater than 65%, more preferably equal to or greater than 70%, and particularly preferably equal to or greater than 75%.

Also in this half shell 54, proportion of the thickness Ts of the side part 58 to the nominal thickness T of the cover is preferably equal to or greater than 100%, and more preferably equal to or greater than 105%. The proportion is preferably equal to or less than 120%, and particularly preferably equal to or less than 115%.

Proportion of total volume of two half shells 54 to the volume of the cover 6 is preferably equal to or greater than 110%, and more preferably equal to or greater than 120%. This proportion is preferably equal to or less than 130%, and more preferably equal to or less than 125%.

### EXAMPLES

### Example 1

A rubber composition was obtained by kneading 100 parts by weight of polybutadiene (trade name “BR 18”, available from JSR Corporation), 35 parts by weight of zinc acrylate, 5.0 parts by weight of zinc oxide, 13.4 parts by weight of barium sulfate, 0.8 part by weight of diphenyl disulfide (manufactured by Sumitomo Seika Chemicals Co., Ltd.) and 0.5 part by weight of dicumyl peroxide in an internal kneading machine. This rubber composition was placed into a mold having upper and lower mold half each having a hemispherical cavity, and heated under a temperature of 170° C. for 15 minutes to obtain a center having a diameter of 38.5 mm.

A binary ionomer resin neutralized with sodium (“Himilan 1605”, described above) in an amount of 50 parts by weight and 50 parts by weight of an ionomer resin neutralized with zinc (“Himilan AM 7329”, described above) were blended, and extruded with a twin screw extruder to obtain a resin composition. This resin composition had an incipient fluidization temperature Fm of 92.2° C. A mid layer was obtained by covering this resin composition around the center by injection molding. This mid layer had a thickness of 1.62 mm.

A thermoplastic polyurethane elastomer (“Elastollan XNY97A”, described above) in an amount of 100 parts by weight and 4 parts by weight of titanium dioxide were blended, and extruded with a biaxial extruder to obtain a resin composition. The extrusion conditions are as follows:
temperature: 230° C.;
screw diameter: 45 mm;
screw rotation speed: 200 rpm; and
L/D of screw: 35.
   This resin composition had an incipient fluidization temperature Fc of 115° C. This resin composition was cut to give cylindrical pellets. This pellet had a diameter of 20 mm, and a weight of about 2 g. Each one piece of this pellet was placed into every recessed part of a first mold, and a preforming material having numerous half shells was obtained by compression molding. This half shell had a shape as shown in FIG. 5. Conditions of the compression molding are as follows:
molding temperature: 170° C.;
compressive force of primary compression step: 7845 N;
time period of primary compression step: 2 min;
compressive force in secondary compression step: 26478 N;
time period of secondary compression step: 3 min;
compressive force in cooling step: 26478 N; and
time period of cooling step: 5 min.

The core composed of the center and the mid layer was sandwiched between two pieces of the preforming material, placed into a second mold to form a cover by compression molding. Conditions of the compression molding are as follows:
molding temperature: 140° C.;
speed in mold clamping step: 1.0 mm/s;
compressive force in high pressure step: 26478 N; and
time period of high pressure step: 150 sec.

Painting was applied on the surface of this cover to obtain a golf ball. This golf ball had a diameter of 42.75 mm.

### Examples 2 to 4 and Comparative Examples 1 to 3

In a similar manner to Example 1 except that the shape of the half shell was as shown in Table 1 below, golf balls were obtained.

### Examples 5 to 6 and Comparative Example 4

In a similar manner to Example 1 except that the thickness of the mid layer and the thickness of the half shell were as shown in Table 2 below, golf balls were obtained.

### Examples 7 to 9

In a similar manner to Example 1 except that the conditions of the compression molding were as shown in Table 2 below, golf balls were obtained.

### Comparative Example 5

In a similar manner to Example 1 except that a thermoplastic polyamide elastomer (trade name “PEBAX 7233”, available from Toray Industries, Inc) was used as a base polymer of the resin composition for the mid layer, a golf ball was obtained. This resin composition had an incipient fluidization temperature Fm of 165° C.

[Measurement of Cover Thickness]

The golf ball was cut along a plane that passes through the upper pole and the lower pole, and the enlarged image of the cross section was obtained. In this image, the thickness T1 at the upper pole, the thickness T2 at the lower pole, the thickness T3 at one seam and the thickness T4 at another seam were measured with a slide caliper. The thicknesses T1, T2, T3 and T4 were measured immediately below the land while avoiding the dimples. Then, average of the thickness T1 and the thickness T2 was calculated to determine a pole thickness P; average of the thickness T3 and the thickness T4 was calculated to determine a seam thickness S; and the difference (P−S) between the pole thickness P and the seam thickness S was measured. Furthermore, values were determined by subtracting the minimum value from the maximum value among the thicknesses T1, T2, T3 and T4 to give the value of uneven thickness. Mean values of the data obtained by measuring on 24 golf balls are shown in Table 1 and Table 2 below.

[Visual Observation]

Appearance of the 24 golf balls was visually observed, and the presence of the golf ball accompanied by occurrence of bare was determined. At the same time, the presence of the golf ball including residual air within the cover was determined. The results are shown in Table 1 and Table 2 below.

[Durability Test]

A driver with a metal head was attached to a swing machine available from True Temper Co. Then the golf balls were hit 100 times under a condition to give the head speed of 45 m/sec. Six golf balls were subjected to the test, and the presence of those accompanied by occurrence of breakage was visually determined. The results are shown in Table 1 and Table 2 below.

TABLE 1
Results of evaluation

| | | Compara. | | | | Compara. | Compara. | |
|---|---|---|---|---|---|---|---|---|
| | | Example 1 | Example 2 | Example 1 | Example 3 | Example 2 | Example 3 | Example 4 |
| Intended thickness of cover (mm) | | 0.50 | 0.50 | 0.50 | 0.50 | 0.50 | 0.50 | 0.50 |
| Mid layer | thickness (mm) | 1.62 | 1.62 | 1.62 | 1.62 | 1.62 | 1.62 | 1.62 |
| Half shell | top part thickness Tt (mm) | 0.27 | 0.35 | 0.40 | 0.45 | 0.55 | 0.37 | 0.40 |
| | (Tt/T) * 100 (%) | 60 | 67 | 78 | 88 | 106 | 80 | 80 |
| | side part thickness Ts (mm) | 0.50 | 0.55 | 0.55 | 0.55 | 0.57 | 0.37 | 0.50 |
| | (Ts/T) * 100 (%) | 110 | 108 | 108 | 108 | 110 | 80 | 100 |
| Cover | nominal thickness T (mm) | 0.45 | 0.51 | 0.51 | 0.51 | 0.52 | 0.46 | 0.50 |
| | pole thickness P (mm) | 0.38 | 0.47 | 0.49 | 0.52 | 0.59 | 0.50 | 0.51 |
| | seam thickness S (mm) | 0.49 | 0.52 | 0.50 | 0.51 | 0.50 | 0.38 | 0.47 |

| | | | | | | | |
|---|---|---|---|---|---|---|---|
| Speed in mold clamping step (mm/s) | 1.0 | 1.0 | 1.0 | 1.0 | 1.0 | 1.0 | 1.0 |
| Compressive force | 26478 | 26478 | 26478 | 26478 | 26478 | 26478 | 26478 |
| in high pressure step (N) | | | | | | | |
| Recessed part on mid layer | present | present | present | present | present | present | present |
| Ball diameter (mm) | 42.64 | 42.75 | 42.75 | 42.76 | 42.77 | 42.65 | 42.74 |
| P − S (mm) | −0.11 | −0.05 | −0.01 | 0.01 | 0.09 | 0.12 | 0.04 |
| Uneven thickness (mm) | 0.11 | 0.05 | 0.01 | 0.01 | 0.09 | 0.12 | 0.04 |
| Bare | present | absent | absent | absent | absent | present | absent |
| Air inclusion | absent | absent | absent | absent | absent | absent | absent |
| Breakage | present | absent | absent | absent | absent | present | absent |

TABLE 2
Results of evaluation

| | | | | Compara. | | | | Compara. |
|---|---|---|---|---|---|---|---|---|
| | | Example 5 | Example 6 | Example 4 | Example 7 | Example 8 | Example 9 | Example 5 |
| Intended thickness of cover (mm) | | 0.30 | 0.80 | 0.90 | 0.50 | 0.50 | 0.50 | 0.50 |
| Mid layer | thickness (mm) | 1.83 | 1.33 | 1.23 | 1.62 | 1.62 | 1.62 | 1.62 |
| Half shell | top part thickness Tt (mm) | 0.26 | 0.70 | 0.80 | 0.40 | 0.40 | 0.40 | 0.40 |
| | (Tt/T) * 100 (%) | 87 | 88 | 89 | 85 | 78 | 87 | 78 |
| | side part thickness Ts (mm) | 0.33 | 0.90 | 1.00 | 0.55 | 0.55 | 0.55 | 0.55 |
| | (Ts/T) * 100 (%) | 110 | 113 | 111 | 117 | 108 | 120 | 108 |
| Cover | nominal thickness T (mm) | 0.30 | 0.80 | 0.90 | 0.47 | 0.51 | 0.46 | 0.51 |
| | pole thickness P (mm) | 0.29 | 0.78 | 0.84 | 0.44 | 0.49 | 0.48 | 0.49 |
| | seam thickness S (mm) | 0.31 | 0.81 | 0.95 | 0.46 | 0.50 | 0.49 | 0.50 |

| | | | | | | | |
|---|---|---|---|---|---|---|---|
| Speed in mold clamping step (mm/s) | 1.0 | 1.0 | 1.0 | 0.3 | 3.0 | 1.0 | 1.0 |
| Compressive force | 26478 | 26478 | 26478 | 26478 | 26478 | 13239 | 26478 |
| in high pressure step (N) | | | | | | | |
| Recessed part on mid layer | present | present | present | present | present | present | absent |
| Ball diameter (mm) | 42.75 | 42.75 | 42.74 | 42.68 | 42.75 | 42.66 | 42.75 |
| P − S (mm) | −0.02 | −0.03 | −0.11 | −0.02 | −0.01 | −0.01 | −0.01 |
| Uneven thickness (mm) | 0.02 | 0.03 | 0.11 | 0.02 | 0.07 | 0.06 | 0.01 |
| Bare | absent | absent | absent | absent | absent | absent | absent |
| Air inclusion | absent | absent | present | present | absent | absent | absent |
| Breakage | absent | absent | present | absent | absent | absent | present |

As is clear from Table 1 and Table 2, the golf balls obtained by the method of the production of Examples exhibited a small value of (P−S), and were excellent in durability. In contrast, the golf balls obtained by the method of the production of Comparative Examples 1 to 4 exhibited a great value of (P−S). In addition, the golf ball obtained by the method of the production of Comparative Example 5 was inferior in durability. Accordingly, advantages of the present invention are clearly indicated by these results of evaluation.

The description herein above is merely for illustrative examples, and various modifications can be made without departing from the principles of the present invention.

What is claimed is:

1. A method of the production of a golf ball which comprises:
a core forming step in which a center is covered by a mid layer comprising a thermoplastic resin composition to obtain a core;
a half shell forming step in which a half shell is formed which comprises other thermoplastic resin composition and is bowl-shaped;
a placing step in which the core, and two pieces of the half shell fitted to said core are placed in a mold comprising an upper mold half and a lower mold half having a hemispherical cavity face andhaving numerous pimples on the surface thereof, in the state of this mold being released;
a mold clamping step in which said mold is clamped to allow the thermoplastic resin composition of the half shell to be compressed in the spherical cavity while being heated, thereby discharging excessive thermoplastic resin composition from the spherical cavity, and pushing the mid layer by the pimples to form recesses; and
a hardening step in which the thermoplastic resin composition remaining in the spherical cavity is hardened to form a cover having a nominal thickness T of 0.1 mm or greater and 0.8 mm or less
said half shell obtained in the half shell forming step having a top part thickness Tt of 65% or greater and 95% or less of the nominal thickness T, and a side part thickness Ts of 100% or greater and 120% or less of the nominal thickness T.

2. The method of the production according to claim 1 wherein mold clamping speed in said mold clamping step is 0.5 mm/s or greater and 2.0 mm/s or less.

3. The method of the production according to claim 1 which further comprises following said mold clamping step a high pressure step in which the resin composition of the half shell is compressed in the spherical cavity under a pressure that is higher than the pressure in the mold clamping step.

4. The method of the production according to claim 3 wherein the compressive force in said high pressure step is 17652 N or greater and 40207 N or less.

5. The method of the production according to claim 3 wherein time period of said high pressure step is 30 sec or longer and 300 sec or shorter.
